(19) United States
(12) Patent Application Publication
(10) Pub. No.: US 2016/0285101 A1
(43) Pub. Date: Sep. 29, 2016

(54) ELECTRODE FOR NONAQUEOUS ELECTROLYTE BATTERY, NONAQUEOUS ELECTROLYTE BATTERY AND BATTERY PACK

(71) Applicant: Kabushiki Kaisha Toshiba, Minato-ku (JP)

(72) Inventors: Sara YOSHIO, Daito (JP); Takayuki Fukasawa, Yokohama (JP); Miho Muramatsu, Yokohama (JP); Yasuyuki Hotta, Ota (JP); Takashi Kuboki, Ota (JP)

(73) Assignee: Kabushiki Kaisha Toshiba, Minato-ku (JP)

(21) Appl. No.: 15/078,033

(22) Filed: Mar. 23, 2016

(30) Foreign Application Priority Data
Mar. 25, 2015 (JP) 2015-062622

(51) Int. Cl. H01M 4/62; H01M 10/0525; H01M 10/42; H01M 4/36; H01M 4/48

(52) U.S. Cl. CPC H01M 4/622; H01M 4/364; H01M 4/483; H01M 10/425; H01M 10/0525

(57) ABSTRACT

In one embodiment, an electrode for a nonaqueous electrolyte battery is provided with a collector, a first mixture layer formed on the collector, and a second mixture layer formed on a surface of the first mixture layer which is opposite to the collector, and the first mixture layer contains a first binding agent of at least one kind of polyamic acid, polyamide-imide and polyimide, and the second mixture layer contains a second binding agent obtained by polymerizing monomers of at least one kind of acrylic acid, methacrylic acid and acrylonitrile.

### CROSS-REFERENCE TO RELATED APPLICATION

This application is based upon and claims the benefit of priority from the prior Japanese Patent Application No. 2015-062622, filed on Mar. 25, 2015, the entire contents of which are incorporated herein by reference.

### FIELD

Embodiments described herein relate generally to an electrode for a nonaqueous electrolyte battery, a nonaqueous electrolyte battery and a battery pack.

### BACKGROUND

Recently, various portable electronic devices have become widespread, by the rapid development of a miniaturization technology of an electronics device. And miniaturization is also required for batteries which are power sources for these portable electronic devices, and a nonaqueous electrolyte secondary battery having a high energy density has attracted attention.

An effort is made to use particularly an element which is alloyed with lithium, such as silicon, tin, or a material having a large lithium insertion capacity and a high density, such an amorphous chalcogen compound. Among them, silicon can insert lithium up to a ratio of 4.4 lithium atoms to 1 silicon atom.

For the reason, when such a material is used as a nonaqueous electrolyte secondary battery, a negative electrode capacity per mass thereof is about 10 times of the case in which graphite carbon that has conventionally been used is used as the negative electrode material. But regarding silicon, since change of the volume in accompany with insertion and extraction of lithium in a charge/discharge cycle is large, deterioration due to pulverization and separation at the collector interface and so on have become a problem.

In order to solve the above-described problem, a method is proposed in which, so as to suppress the occurrence of the problem caused by the change of volume of silicon in accompany with the above-described insertion and extraction of lithium, an intermediate layer containing a carbon material with a small volume change is interposed between a negative electrode mixture layer composed of these negative electrode materials and a collector on which the above-described negative electrode mixture layer is to be formed, to prevent the separation of the negative electrode active material layer from the collector (Patent Document 1).

However, according to the method to interpose the above-described intermediate layer containing the carbon material, stress strain to be generated by the volume expansion at the time of charge/discharge is easy to occur, between the layer containing the carbon material and the negative electrode mixture layer, and even if the separation from the collector may be suppressed, the binding property of the mixture layer and the intermediate layer cannot be maintained. It is thought that this problem becomes more apparent, as the nonaqueous electrolyte battery has a higher capacity, and accordingly a measure is required.

Generally, a binding agent such as polyimide and polyacrylic acid has a strong binding force between active materials, and is used as a binding agent for an electrode using an active material using an alloying reaction in which a volume change is large in the charge/discharge reaction. However, though a polyimide system binder has a strong binding force, since it has an irreversible capacity, there is a problem that charge/discharge efficiency might become low at an early stage of the cycle.

On the other hand, a binding agent such as polyacrylic acid does not have an irreversible capacity, but the binding force differs depending on the material of the collector, and there is a problem that the binding force thereof with a copper foil containing various additives called a high strength material, and a stainless-steel foil is insufficient, and thereby the separation is easy to occur.

### BRIEF DESCRIPTION OF THE DRAWINGS

FIG. 1 is a conceptual diagram of an electrode of a first embodiment.

FIG. 2 is a conceptual sectional diagram of a nonaqueous electrolyte battery of a second embodiment.

FIG. 3 is an enlarged conceptual sectional diagram of the nonaqueous electrolyte battery of the second embodiment.

FIG. 4 is a conceptual diagram of a battery pack of a third embodiment.

FIG. 5 is a block diagram showing an electric circuit of the battery pack of the third embodiment.

### DETAILED DESCRIPTION

Hereinafter, embodiments to practice the invention will be described with reference to the drawings.

### First Embodiment

An electrode for a nonaqueous electrolyte battery of a first embodiment is provided with a collector, a first active material mixture layer formed on the collector, and a second active material mixture layer formed on a surface of the first active material mixture layer which is opposite to the collector, and the first mixture layer contains a first binding agent of at least one kind of polyamic acid, polyamide-imide and polyimide, and the second mixture layer contains a second binding agent obtained by polymerizing monomers of at least one kind of acrylic acid, methacrylic acid and acrylonitrile.

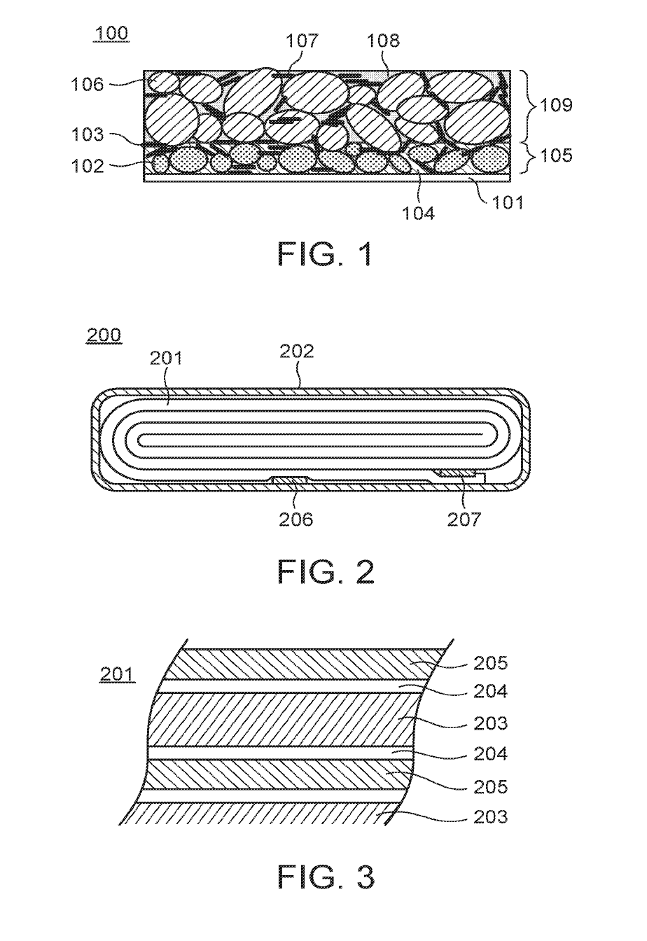

FIG. 1 is a conceptual diagram of an electrode for a nonaqueous electrolyte battery of the embodiment. An electrode 100 of the first embodiment is used as a negative electrode, for example. The electrode 100 includes a collector 101, a first mixture layer 105 formed on the collector 101, and a second mixture layer 109 formed on a surface of the first mixture layer 105 which is opposite to the collector 101.

The collector 101 is a conductive member which is bound with the first mixture layer 105. As the collector 101, a conductive substrate of a porous structure or a nonporous conductive substrate can be used. These conductive substrates can be formed of copper, stainless-steel or nickel, for example. A thickness of the collector 101 is preferably not less than 5 μm and not more than 20 μm. This is because, if the thickness of the collector 101 is in this range, the balance between electrode strength and weight saving can be obtained.

Hereinafter, description will be made, assuming that the electrode for a nonaqueous electrolyte battery of the embodiment is used for a nonaqueous electrolyte battery, but without being limited to this, it can be used for various batteries.

The first mixture layer 105 is a mixture layer which is formed on and in contact with the collector 101, and in which a first active material 102 and a first conductive agent 103 are bound by a first binding agent 104.

At least one kind of polyamic acid, polyamide-imide and polyimide is used as the first binding agent. Since these binding agents themselves have a relatively large irreversible capacity, when the electrode for a nonaqueous electrolyte battery of the present embodiment is used for a nonaqueous electrolyte battery, a first charge/discharge efficiency becomes lower compared with other binding agents. However, according to the present embodiment, the binding agent has an excellent binding property irrespective of the kind of the conductive member used in the collector 101, and the first mixture layer 105 can be tightly bound on the collector 101 by the heat treatment at the time of manufacturing.

The second mixture layer 109 is a mixture layer which is formed on a surface of the first mixture layer 105 opposite to the collector 101, and in which a second active material 106 and a second conductive agent 107 are bound by a second binding agent 108.

As the second binding agent 108, one obtained by polymerizing monomers of at least one kind of acrylic acid, methacrylic acid and acrylonitrile is used. Regarding the second binding agent 108, one kind of the second binding agent 108 can be used, or a plural kinds of the second binding agents 108 may be used. Acrylic acid contains carboxylic acid, and it is preferably to use one in which not less than 50% of carboxylic acid is neutralized by ions of alkali metal of at least one kind of lithium, sodium, and potassium. This is because, being made to metal salt, thereby a solubility thereof to water is increased. Since it contains metal salt of not less than 50%, a high density solution can be prepared, and it is possible to help adjustment of the solid content ratio, and creation of electrode in the coating. Since the second binding agent has a small irreversible capacity, high first charge/discharge efficiency can be realized. But, when the second mixture layer using this second binding agent is formed directly on the collector 101, the binding property differs depending on the kind of the conductive member to be used in the collector 101. The binding force of the second mixture layer with a collector using a copper foil containing various additives called a high strength material or a stainless-steel foil is insufficient, and thereby the separation is easy to occur. For the reason, it is difficult to use such a second mixture layer at a portion directly contacting with the collector 101. On the other hand, since these second binding agents bind active materials to each other between the active materials, and have a property excellent in elasticity, they can correspond to the volume change of the active material by charge/discharge, and do not impair the binding property between the active materials. For the reason, since these second binding agents 108 are formed as the second mixture layer 109 on a surface of the first mixture layer 105 which is opposite to the collector 101, and thereby they do not contact with the collector 101, it is possible to obtain a nonaqueous electrolyte battery which is excellent in the binding property with the first mixture layer 105 and excellent in the charge/discharge efficiency.

As described above, the first mixture layer 105 containing the first binding agent 104 is formed on the collector 101, and thereby the binding property between the collector 101 and the first mixture layer 105 is improved, and in addition, the second mixture layer 109 containing the second binding agent 108 is formed on the surface of the first mixture layer 105 which is opposite to the collector 101, and thereby it is possible to obtain an excellent charge/discharge characteristic.

Further, it is preferable that, in order to increase the binding force between these mixture layers, at the boundary surface of the first mixture layer 105 and the second mixture layer 109, the binding agents contained in the respective layers contact with the active materials and conductive carbon materials in the other layers, and for example, it is preferable that the first mixture layer 105 and the second mixture layer 109 form an interface in which the respective constituent components are intricate.

Further, regarding the respective active materials and the conductive carbon materials contained in the first mixture layer or the second mixture layer, it is more preferable that, in order to prevent the separation at the interface of the first layer 105 and the second layer 109 by the volume change due to the energy density differences, the active material and the conductive carbon material are of a composition in which a mixing ratio thereof is gradient.

The first active material 102 contained in the first mixture layer 105, or the second active material 106 contained in the second mixture layer 109 is an element which can be alloyed with Li, and a particle containing an element of at least one kind of Si, Sn, Al, Ge, Pb, Bi and Sb. Regarding these elements, the element alone, an alloy containing the element, an oxide thereof or a mixture thereof can be used. When the alloy is used, a metal element other than the above-described elements, such as Ti may be contained in the alloy. This is because, this Ti is contained, and thereby the conductivity is improved. Hereinafter, for the simplification of the description, regarding an element and an oxide using the element, silicon and silicon oxide will be described as an example. Regarding the first active material 102 and the second active material 106, one kinds thereof can be used, or a plural kinds thereof may be used, respectively.

Particles of silicon and silicon oxide contained in the first active material 102 and the second active material 106 may be crystalline or amorphous. Particularly, it is desirable that they are a crystalline material. This is because, if the particle is a crystalline material, there is a tendency that, it has an excellent cycle characteristic when subjected to a charge/discharge cycle. In addition, silicon and silicon oxide may be in the form in which a silicon particle is coated with silicon oxide.

The above-described first active material 102 and the above-described second active material 106 are a combination of a particle of an element alone and a particle of its oxide, such as silicon and silicon oxide, or a composite particle in which these materials are dispersed in a carbonaceous material.

In addition, carbon fiber may be contained, in the carbonaceous material of the composite particle, in order to hold the structure of the particle, prevent aggregation of silicon and silicon oxide, and improve the conductivity. An average diameter of this carbon fiber is preferably not less than 10 nm and not more than 1000 nm. If the average diameter of the carbon fiber is too small, it is difficult to make it uniformly exist in the carbonaceous material, and might rather reduce the strength of the carbonaceous material. If the average diameter thereof is too large, since the carbon fiber is too large for silicon and silicon oxide, it is rather easy to become a defect. Regarding the carbon fiber, it is preferable that a short diameter thereof is not less than 1 nm and not more than 100 nm, and an aspect ratio thereof is not less than 50. If a contained amount of the carbon fiber is too large, the battery capacity might be decreased, and thereby it is preferable that the carbon fiber of not more than 5 mass % is contained in the active material. More preferably, it is not less than 0.1 mass % and not more than 2 mass.

Regarding the composite particle, any of silicon, silicon oxide or the like and a carbon precursor are mixed in a liquid phase using a dispersion medium, the mixture is dried and solidified, and then burned and thereby the composite particle is manufactured. Or it may be a matter obtained by mixing and compounding with the carbonaceous material.

In addition, when identifying the binding agents of the first layer and the second layer which have been formed, to begin with the electrode is washed, and then the second layer binder is extracted with water medium, and the structure thereof is identified using NMR (Nuclear Magnetic Resonance) or IR (Infrared spectroscopy). Regarding the first layer, after the above-described washing, an imide group is to be detected by IR in the remaining electrode.

The active material consisting of the composite particle like this can be manufactured with a method as described below, for example.

To begin with, a carbon precursor dispersion medium which will become a carbonaceous material by being carbonized with heat treatment, silicon and silicon oxide are mixed.

As the carbon precursor, an organic compound, such as a monomer that is a liquid and can easily be polymerized, an oligomer, or the like is used. For example, fran resin, xylene resin, ketone resin, amino resin, melamine resin, urea resin, aniline resin, urethane resin, polyimide resin, polyester resin, phenol resin or a monomer thereof can be listed. As a specific monomer, a fran compound, such as furfuryl alcohol, furfural, furfural derivative or the like can be listed, and the monomer is used by being polymerized in the mixture of the composite material. A polymerization method differs depending on the carbon precursor, and hydrochloric acid, acid anhydride may be added to it, or it may be heated. In addition, solid powder such as sucrose, ascorbic acid, citric acid can be used as the carbon precursor.

As the dispersion medium, water, ethanol, isopropyl alcohol, acetone, N-methylpyrrolidone, methyl ethyl ketone, fatty acid such as oleic acid or linoleic acid can be listed. This is because, it is desirable to be a liquid not to react with a material to be mixed using the dispersion medium. As a mixing method using the dispersion medium may be a solid kneading method in which an amount of a liquid phase to a solid phase is small, or a mixed agitating method in which an amount of a liquid phase to a solid phase is large. A mixed agitating method can be performed by various agitating apparatuses, a ball mill, a bead mill apparatus and a combination of these. In addition, mixing can be performed in a part of the mixing process while heating.

The mixture after mixing is dried and solidified. Drying of the mixture is performed by leaving it in the atmosphere, or by heating it, for example. Solidification of the mixture may be performed by the polymerization of the carbon precursor, or the mixture may be solidified at the same time of the drying. These methods are appropriately selected depending on the kind of the carbon precursor.

In addition, in order to hold the structure of the active material composite particle, and prevent aggregation of the silicon containing particles, it is preferable that zirconia or stabilized zirconia is contained in the active material. This is because, aggregation of the silicon containing particles is prevented, and thereby a merit to improve a cycle characteristic is obtained.

It is preferable to arrange the active material obtained by being manufactured as described above, in the first mixture layer 105 and the second mixture layer 109, so that the following requirements are satisfied.

When an energy density per volume of the first mixture layer 105 is set to X1, and an energy density per volume of the second mixture layer 109 is set to X2, it is preferable that X1≦X2.

Energy densities of the first mixture layer 105 and the second mixture layer 109 change depending on \textcircled{1} a silicon contained amount in the active material to be used in each layer, \textcircled{2} a mixing ratio of the conductive agent in the active material of each layer, \textcircled{3} a used amount of the binder in each layer, \textcircled{4} a density of each active material mixture layer, and so on. Regarding the first active material 102 of the first mixture layer 105 contacting with the collector 101, since it is necessary to maintain the binding force with the collector 101, and decrease the stress resulted from the volume change caused by charge/discharge, it is preferable that the energy density X1 is lower. But, when the energy density becomes low, the characteristic as the battery deteriorates, and accordingly, it is preferable to make the energy density in the second mixture layer high. In addition, when a stress difference resulted from the volume changes of the first mixture layer and the second mixture layer caused by charge/discharge is large, since the separation might occur at the interface of the first mixture layer 105 and the second mixture layer 109, it is preferable that a difference between X1 and X2 is smaller. Accordingly, it is preferable that the relation between the energy density X1 of the first mixture layer and the energy density X2 of the second mixture layer is set as X1≦X2. The energy density at this time is to be calculated using the volume of the electrode before charge/discharge. In addition, with respect to the calculation of energy densities of the first layer and the second layer, regarding the first layer, in the same manner as the time of identifying the binding agent, to begin with, the electrode is washed, and then the second layer is removed from the electrode with water medium, and the electrode is dried and subjected to charge/discharge, and then, the energy density is calculating by dividing the capacity by the volume of the electrode material. On the other hand, the energy density of the second layer is calculated by subtracting the charging capacity of the first layer from the total charging capacity of the first layer and the second layer, and then dividing the difference by the volume of the electrode material of the second layer.

In addition, when a thickness of the first mixture layer 105 is set to Y1, and a thickness of the above-described second mixture layer 109 is set to Y2, it is preferable that Y1≦Y2. The thickness Y1 of the first mixture layer 105 contacting with the collector 101 is set equivalent to or lower than the thickness Y2 of the second mixture layer 109. If the first mixture layer 105 is too thin, it follows the volume change of the second mixture layer 109, resulting in collapse of the first mixture layer 105, or separation from the collector 101.

Here, it is preferable that a total (Y1+Y2) of the thicknesses of the first active material mixture layer 105 and the second active material mixture layer 109 formed on one surface of the collector 101 is not less than 10 μm and not more than 150 μm, and preferably is not less than 30 μm and not more than 100 μm. If the total is in this range, a large current discharge characteristic and a cycle characteristic are improved. The thickness Y1 of the first mixture layer 105 is not more than 20 μm, and is preferably not more than 10 μm. If the first mixture layer 105 is too thin, it follows the volume change of the second mixture layer 109, resulting in collapse of the first mixture layer 105, or separation from the collector 101. On the other hand, this is because, if the first mixture layer 105 is too thick, high capacity cannot be obtained.

In addition, the thickness of the mixture layer called here is obtained as follows. To begin with, a cross section thereof cut approximately vertically to the collector in the thickness direction is observed by a scanning electron microscope (SEM: Scanning Electron Microscopy) at a magnification of 2000. At this time, a line is drawn in approximately parallel with a foil, in which a plurality of contact points of the first layer active material and the second layer active material existing at the boundary of the first mixture layer and the second mixture layer pass. A length of a perpendicular line drawn from this line to the surface of the collector is measured at places which are obtained by equally sectioning the point of view obtained by SEM into ten or more points, and an average value thereof is determined as the thickness Y of the first mixture layer. In addition, an average value of lengths of perpendicular lines drawn from the surface of the second mixture layer to the surface of the collector, at positions where the thicknesses of the above-described first mixture layer have been measured, is determined as the total (Y1+Y2) of the thicknesses of the first mixture layer 105 and the second mixture layer 109. A value obtained by subtracting the thickness Y1 of the first mixture layer from this total value is determined as the thickness Y2 of the second mixture layer 109.

In addition, when an average particle diameter of the first active material 102 is set to Z1, and an average particle diameter of the second active material 106 is set to Z2, it is preferable that Z1≦Z2. It is preferable that the average particle diameter Z1 of the first active material 102 is set equivalent to or lower than the average particle diameter Z2 of the second active material 106, because it is possible to prevent that the second active material 106 in the second active material mixture layer 109 sinks into the first active material mixture layer 105, at the time of manufacturing the electrode. If the average particle diameter Z1 of the first active material 102 is too small, the necessity of the binder increases, and since the irreversible capacity derived from the binder increases, and that is not preferable, regarding Z1 to Z2, it is preferable that 1≦Z1/Z2<100.

Here, it is preferable that the average particle diameters Z1, Z2 of the above-described first active material 102 and the second active material 106 are not less than 0.1 μm and not more than 20 μm. This is because, an average particle diameter of an active material affects the speed of insertion and extraction reaction of lithium, and has a large effect to the electrode characteristic, but if the average particle diameter is a value in this range, it is possible to stably exert the characteristic.

In addition, since it is necessary that the above-described first active material 102, while maintaining the binding force with the collector 101, disperses the stress resulted from the volume change caused by charge/discharge, it is better that the average particle diameter is smaller, and preferably it is not more than 5 μm. On the other hand, in addition, the average particle diameter of the active material called here is obtained as follows. To begin with, a cross section thereof cut approximately vertically to the collector in the thickness direction is observed by SEM at a magnification of 2000. An average value of a long diameter and a short diameter of the active material which has been randomly selected in the obtained image is calculated, and an average of not less than 10 average values is determined as an average diameter.

Regarding the conductive agent, the first conductive agent 103 and the second conductive agent 107 have effects to enhance the respective conductivities of the first active material 102 and the second active material 106, and accordingly it is preferable that they exists dispersely in the respective active material mixture layers 105, 109. As the conductive agent, acetylene black, carbon black, graphite or the like can be listed. As the conductive agent, one with a shape, such as a scale shape, a crushed shape, a fiber shape is used. These conductive agents are used such that one kind is used alone, or two or more kinds are used in combination. In many cases, the conductive agent can also perform the insertion and extraction of Li, but its charge/discharge capacity is smaller compared with the first active material 102 and the second active material 106 described above. In the present embodiment, one which mainly performs the insertion and extraction of Li is made the active material, and the above-described material is made the conductive agent.

### (Manufacturing Method)

An example of a manufacturing method of the electrode for a nonaqueous electrolyte battery of the first embodiment will be described.

The first active material 102, the first conductive agent 103 and the first binding agent 104 are suspended in a generally-used solvent, to prepare slurry. The obtained slurry is applied to the collector 101, dried and pressed, and then is subjected to heat treatment in an inert atmosphere at 250-450° C., and thereby the first mixture layer 105 is manufactured. Spraying, spin coating or the like may be used, for application of the slurry.

Next, the second active material 106, the second conductive agent 107 and the second binding agent 108 are suspended in a generally-used solvent, to prepare slurry. The obtained slurry is applied on a surface of the first mixture layer 105 which is opposite to the collector 101, dried and pressed, and thereby the second mixture layer 109 is manufactured. Embedding of the second mixture layer 109 into the first mixture layer 105 can be adjusted, depending on the pressure of pressing.

### Second Embodiment

A nonaqueous electrolyte battery according to a second embodiment will be described.

The nonaqueous electrolyte battery according to the second embodiment uses the electrode for a nonaqueous electrolyte battery of the first embodiment. Specifically, it is provided with an exterior material, a positive electrode which is housed in the external material, a negative electrode which is housed in the external material spatially separately from the positive electrode, with a separator interposed therebetween, for example, and a nonaqueous electrolyte filled in the exterior material. This separator is impregnated with a nonaqueous electrolyte described later.

As an example of the nonaqueous electrolyte battery according to the second embodiment, a flat nonaqueous electrolyte battery (a nonaqueous electrolyte battery) 200 shown in FIG. 2 and FIG. 3 will be described. FIG. 2 is a conceptual sectional diagram of the nonaqueous electrolyte battery of the second embodiment, and FIG. 3 is an enlarged conceptual sectional diagram of an electrode group 201 of the nonaqueous electrolyte battery.

The nonaqueous electrolyte battery 200 shown in FIG. 2 is configured such that the flat wound electrode group 201 is housed in an exterior material 202. The flat wound electrode group 201 is formed by laminating a negative electrode 203, a separator 204, a positive electrode 205, the separator 204 in this order as shown in FIG. 3. And it is formed such that the laminate is wound in a spiral shape and is subjected to press forming. The electrode which is the closest to the external material 202 is a negative electrode, and this negative electrode has a structure that the negative electrode mixture layer is not formed, on a negative electrode collector at the external material 202 side, but the negative electrode mixture layer is formed only on one side of the negative electrode collector at the battery inner surface side. The other negative electrode 203 is configured such that the negative electrode mixture layers are formed on both sides of the negative electrode collector. The positive electrode 205 is configured such that positive electrode mixture layers are formed on both sides of a positive electrode collector.

At the vicinity of an outer circumferential end of the electrode group 201, a negative electrode terminal 206 is electrically connected to the negative electrode collector of the negative electrode 203 at the outermost shell, and a positive electrode terminal 207 is electrically connected to the positive electrode collector of the positive electrode 205 at an inner side. The negative electrode terminal 206 and the positive electrode terminal 207 are extended outside from the exterior material 202, or are connected to lead-out electrodes provided at the exterior material 202. For example, liquid nonaqueous electrolyte is injected from the exterior material 202. In the case of the exterior material 202 consisting of a laminate film described later, the openings of the exterior material 202 are heat sealed while the negative electrode terminal 206 and the positive electrode terminal 207 are sandwiched, and thereby the wound electrode group 201 and the liquid nonaqueous electrolyte are completely sealed.

As the negative electrode terminal 206, a material which is provided with electrical stability and electrical conductivity in the state that a potential to lithium is in a range of not less than 1 V and not more than 3 V can be used. Specifically, aluminum, or aluminum alloy containing an element of Mg, Ti, Zn, Mn, Fe, Cu, Si or the like can be listed. It is preferable that the negative electrode terminal 206 is made of the same material as the negative electrode collector, so as to reduce a contact resistance with the negative electrode collector.

As the positive electrode terminal 207, a material which is provided with electric stability and electrical conductivity in the state that a potential to a lithium ion metal is in a range of not less than 3V and not more than 4.25 V can be used. Specifically, aluminum, or aluminum alloy containing an element of Mg, Ti, Zn, Mn, Fe, Cu, Si or the like can be listed. It is preferable that the positive electrode terminal 207 is made of the same material as the positive electrode collector, so as to reduce a contact resistance with the positive electrode collector.

Hereinafter, the bag-like exterior material 202, the positive electrode 205, the electrolyte, the separator 204 which are the constituent members of the nonaqueous electrolyte battery 200 will be described in detail.

### 1) Exterior Material 202

As the exterior material 202 in which the electrode group 201 and the nonaqueous electrolyte are housed, an exterior container made of a laminate film or a metal container is used.

As the laminate film, a multi-layer film in which a metal layer is interposed between resin layers is used.

The metal layer is preferably an aluminum foil or an aluminum alloy foil for weight reduction. As the resin layer, a polymer material, such as polypropylene (PP), polyethylene (PE), nylon, polyethylene-terephthalate (PET) or the like can be used. The laminate film is sealed by heat fusion, and thereby can be formed in a shape of the exterior material. In addition, a thickness of the laminate film is preferably not more than 0.5 mm, and more preferably not more than 0.2 mm. A purity of an aluminum foil is preferably not less than 99.9%.

The metal container is a metal can made of aluminum, aluminum alloy, iron, stainless-steel or the like, having a square shape, a cylinder shape. In addition, a thickness of the metal container is preferably not more than 1 mm, more preferably not more than 0.5 mm, and further preferably not more than 0.2 mm. The aluminum alloy is preferably an alloy containing an element, such as magnesium, zinc, silicon or the like. When transition metal, such as iron, copper, nickel, chrome or the like is contained in the alloy, its amount is preferably set to not more than 100 mass ppm.

In addition, a shape in the present embodiment can be selected from a flat type (thin type), a square type, a cylinder type, a coin type, and a button type. In an example of the exterior material, an external material for a small type battery which is to be mounted on a portable electronic device or the like, for example, and an external material for a large type battery which is to be mounted on a two-wheel to four-wheel car or the like are included, according to a size of the battery.

### 2) Positive Electrode 205

The positive electrode 205 has a structure that the positive electrode mixture layer containing the positive electrode active material is formed on one side or both sides of the positive electrode collector.

It is preferable that a thickness of the positive electrode mixture layer at one side is in a range of not less than 1 μm and not more than 150 μm, from the point of improving a large current discharge characteristic and a cycle characteristic of the battery. Accordingly, when the positive electrode mixture layers are carried on the both sides of the positive electrode collector, the total thickness thereof is preferably in a range of not less than μm and not more than 300 μm. A more preferable range of a thickness at one side is not less than 30 μm and not more than 120 μm. When the thickness is within this range, the large current discharge characteristic and the cycle characteristic are improved.

The positive electrode mixture layer may contain a conductive agent, in addition to the positive electrode active material, and the binding agent to bind the positive electrode active materials to each other.

Various oxides, such as manganese dioxide, lithium manganese composite oxide, lithium-containing cobalt oxide (LiCOO₂, for example), lithium-containing nickel cobalt oxide (LiNi_{0.8}CO_{0.2}O₂, for example), lithium manganese composite oxide (LiMn₂O₄, LiMnO₂, for example) are used, as the positive electrode active material. It is preferable to use these positive electrode active materials, because high voltage can be obtained.

As the conductive agent, acetylene black, carbon black, artificial graphite, natural graphite, carbon fiber, one containing a conductive polymer or the like can be listed, for example. The kind of the conductive agent can be made to one kind or not less than two kinds.

The binding agent fills the gaps between the dispersed positive electrode active materials, binds the positive electrode active material and the conductive agent, and in addition, binds the positive electrode active material and the positive electrode collector. As the binding agent, polytetrafluoroethlene (PTFE), polyvinylidene fluoride (PVdF), ethylene-propylene-diene copolymer (EPDM), styrene-butadiene rubber (SBR) or the like can be listed, for example. The kind of the binding agent can be made to one kind or not less than two kinds.

In addition, as an organic solvent to disperse the binding agent, N-methyl-2-pyrrolidone (NMP), dimethylformamide (DMP) or the like is used, for example.

Regarding a mixing ratio of the positive electrode active material, the conductive agent and the binding agent, it is preferable to set ranges, of not less than 80 mass % and not more than 95 mass % for the positive electrode active material, not less than 3 mass % and not more than 20 mass % for the conductive agent, and not less than 2 mass % and not more than 7 mass % for the binding agent, because an excellent large current discharge characteristic and cycle characteristic can be obtained, in the nonaqueous electrolyte battery provided with this positive electrode.

As the positive electrode collector, a conductive substrate of a porous structure or a nonporous conductive substrate can be used. A thickness of the collector is preferably not less than 5 μm and not more than 20 μm. This is because, if the thickness is in this range, the balance between an electrode strength and weight saving can be obtained.

Next, a manufacturing method of the positive electrode will be described.

The positive electrode 205 is manufactured by suspending the active material, the conductive agent and the binding agent in a generally-used solvent, to prepare slurry, applying this slurry to the collector, and drying, and then pressing the dried matter. The positive electrode 205 may be manufactured by forming the active material, the conductive agent and the binding agent in a pellet shape, to obtain the positive electrode layer, and by forming this on the collector

### 3) Negative Electrode 203

The electrode of the first embodiment can be used as the negative electrode 203.

### 4) Nonaqueous Electrolyte

As the electrolyte, nonaqueous electrolyte solution, electrolyte impregnated type polymer electrolyte, polymer electrolyte or inorganic solid electrolyte can be used.

The nonaqueous electrolyte solution is a liquid electrolyte solution which is prepared by dissolving the electrolyte in a nonaqueous solvent (organic solvent), and is held in voids in the electrode group.

As the nonaqueous solvent, it is preferable to use a nonaqueous solvent which mainly contains a mixed solvent of cyclic carbonate (hereinafter called “a first solvent”), such as propylene carbonate (PC), ethylene carbonate (EC), and vinylene carbonate, and a nonaqueous solvent (hereinafter referred to as a second solvent) having a lower viscosity than the first solvent.

As the second solvent, chain carbonate, such as dimethyl carbonate (DMC), methyl ethyl carbonate (NEC), diethyl carbonate (DEC), and ethyl propionate, methyl propionate, γ-butyrolactone (GBL), acetonitrile (AN), ethyl acetate (EA), toluene, xylene, or methyl acetate (MA), or the like can be listed, for example. These second solvents can be used solely or in the form of a mixture of two or more kinds. Particularly, regarding the second solvent, because if the number of the donors is too large, the binding with Li ions becomes too strong, and thereby the Li ion conductivity is deceased, it is more preferable that the number of donors is not more than 16.5.

A viscosity of the second solvent is preferably not more than 2.8 cps at 25° C. A blending amount of EC or PC in the mixed solvent of the first solvent and the second solvent is preferably not less than 1% and not more than 80% by a volume ratio. A more preferable blending amount is not less than 20% and not more than 75%. If the volume ratio of the second solvent is too small, the viscosity of the nonaqueous electrolyte solution becomes high, and thereby the Li ion conductivity is decreased, and on the other hand, if the volume ratio of the second solvent is too large, the action of PC or EC is blocked, and thereby the Li ion conductivity is decreased, and accordingly, the above-described range is preferable.

As the electrolyte contained in the nonaqueous electrolyte solution, lithium salt (electrolyte), such as lithium perchlorate (LiClO₄), lithium hexafluorophosphate (LiPF₆), lithium borofluoride (LiBF₄ lithium arsenic hexafluoride (LiAsF₆), lithium trifluoromethanesulfonate (LiCF₃SO₃), bis-trifluoromethylsulfonyl imide lithium [LiN(CF₃SO₂)₂] is listed. Among them, it is preferable to use LiPF₆, LiBF₄. Out of these, it is preferable to use lithium hexafluorophosphate or lithium tetrafluoroborate.

It is preferable to set an amount of dissolution of the electrolyte to the nonaqueous solvent to not less than 0.5 mol/L and not more than 2.0 mol/L. The reason is because, if an amount of dissolution of the electrolyte is too small, the movement of ions hardly occurs, and thereby the Li ion conductivity is decreased, and on the other hand, if an amount of dissolution of the electrolyte is too large, the viscosity of the nonaqueous electrolyte solution becomes high, and thereby the Li ion conductivity is decreased.

### 5) Separator 204

When the nonaqueous electrolyte solution is used, and when the electrolyte impregnated polymer electrolyte is used, the separator 204 can be used. A porous separator is used as the separator 204. As a material of the separator 204, a porous film containing polyethylene (PE), polypropylene (PP), cellulose, or polyvinylidene fluoride (PVdF), synthetic resin nonwoven fabric or the like can be used, for example. Among them, a porous film of polyethylene or polypropylene, or a porous film formed of the both is preferable, because the porous film is melted at a definite temperature, and can block a current, and thereby safety of the battery can be improved.

A thickness of the separator 204 is preferably set to not more than 30 μm. If the thickness exceeds 30 μm, an internal resistance might be increased, because a distance between the positive and negative electrodes is increased. In addition, a lower limit value of the thickness is preferably set to 5 μm. If the thickness is set to less than 5 μm, the strength of the separator 204 is considerably decreased, and thereby an internal short might easily be generated. An upper limit value of the thickness is more preferably set to 25 μm, and a lower limit value thereof is more preferably set to 1.0 μm.

A heat shrinkage percentage of the separator 204 is preferably not more than 20% when held at the condition of 120° C. for one hour. If the heat shrinkage percentage exceeds 20%, a possibility that a short circuit occurs by heating increases. It is more preferable to set the heat shrinkage percentage to not more than 15%.

A porosity of the separator 204 is preferably in a range of not less than 30% and not more than 70%. This is because of the following reason. If the porosity is set to less than 30%, it might become difficult to obtain a high electrolyte holding property in the separator 204. On the other hand, if the porosity exceeds 70%, the sufficient strength of the separator 204 might not be obtained. A more preferable range of the porosity is not less than 35% and not more than 70%.

An air permeability of the separator 204 is preferably not less than 30 second/1.00 cm³ and not more than 500 second/1.00 cm³. If the air permeability is too large, it might become difficult to obtain high lithium ion mobility in the separator 204. In addition, this is because, if the air permeability is too small, sufficient separator strength might not be obtained.

An upper limit value of the air permeability is more preferably set to 300 second/1.00 cm³, and a lower limit value thereof is more preferably set to 50 second/1.00 cm³.

In addition, the nonaqueous electrolyte battery according to the present embodiment can be further provided with a lead to be electrically connected to the electrode group consisting of the above-described positive electrode and negative electrode. The nonaqueous electrolyte battery according to the present embodiment can also be provided with two leads, for example. In this case, one lead is electrically connected to a positive electrode collector tab, and the other lead is electrically connected to a negative electrode collector tab.

A material of the lead is not particularly limited, but the same material as the positive electrode collector and the negative electrode collector is used.

The nonaqueous electrolyte battery according to the present embodiment can be further provided with a terminal which is electrically connected to the above-described lead, and is drawn out from the above-described exterior material. The nonaqueous electrolyte battery according to the present embodiment can also be provided with two terminals, for example. In this case, one terminal is connected to a lead which is electrically connected to a positive electrode collector tab, and the other terminal is connected to a lead which is electrically connected to a negative electrode collector tab.

A material of the terminal is not particularly limited, but the same material as the positive electrode collector and the negative electrode collector is used, for example. As described above, the nonaqueous electrolyte battery of the present embodiment is formed, as the fundamental structure, such that it is provided with the negative electrode having the collector and the first and the second active material layers which are sequentially formed on this collector, the separator adjacent to this negative electrode, the positive electrode formed opposite to the above-described negative electrode via this separator, and the nonaqueous electrolyte to impregnate the separator.

### Third Embodiment

Next, a battery pack according to a third embodiment will be described.

A battery pack according to a third embodiment has one or more nonaqueous electrolyte batteries (that is, unit battery) according to the above-described second embodiment. When a plurality of unit batteries are included in the battery pack, the respective unit batteries are arranged to be electrically connected in series, in parallel, or in series and parallel.

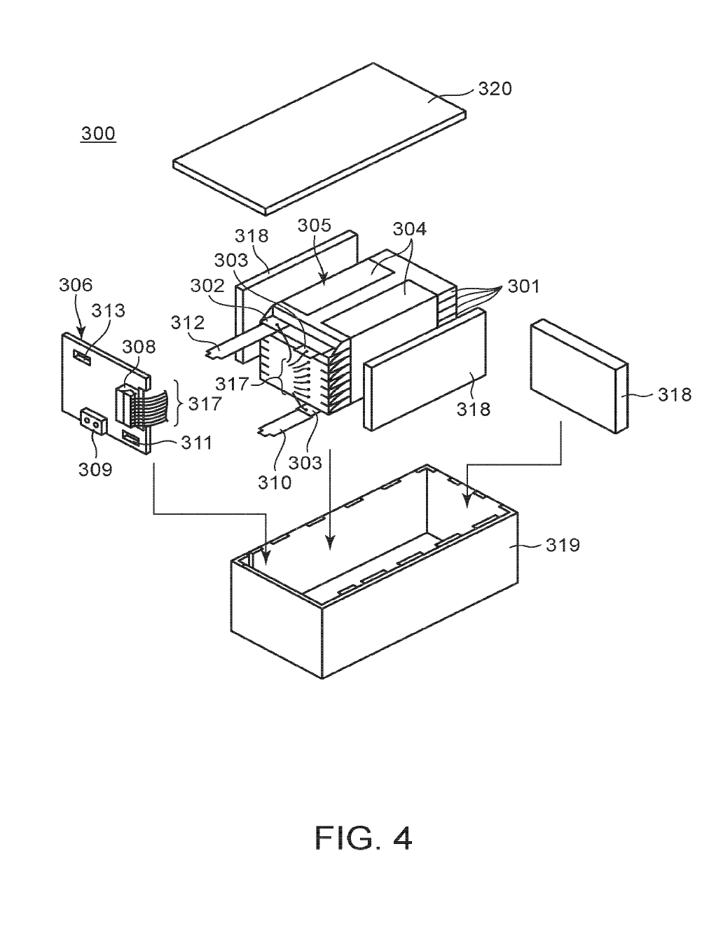

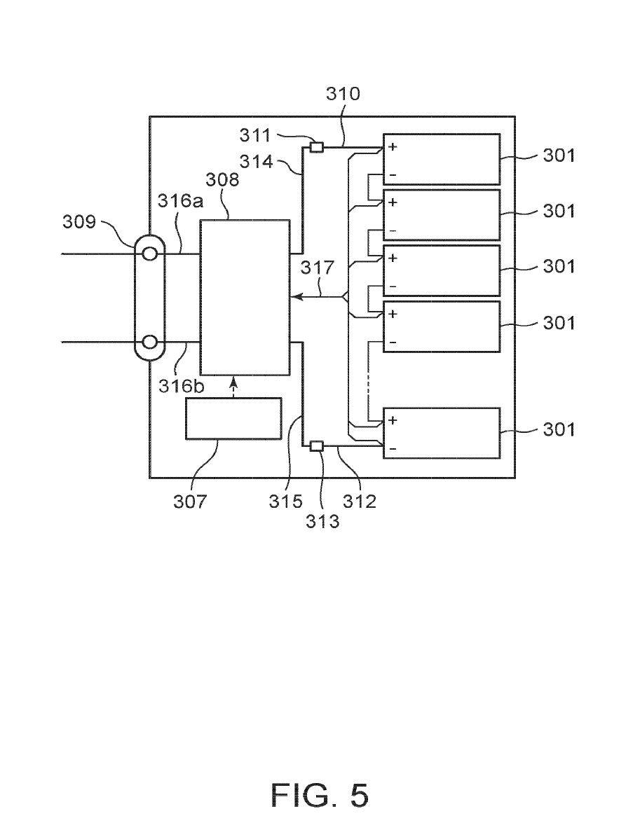

FIG. 4 is a conceptual diagram of the battery pack of the third embodiment, and FIG. 5 is a block diagram showing an electric circuit of the battery pack according to the third embodiment. A battery pack 300 shown in FIG. 4 uses the nonaqueous electrolyte battery 200 shown in FIG. 2, as a unit battery 301.

A plurality of the unit batteries 301 are laminated so that negative electrode terminals 302 and positive electrode terminals 303 which extend outside are aligned in the same direction, and are bound by an adhesive tape 304, to compose an assembled battery 305. These unit batteries 301 are electrically connected in series with each other, as shown in FIG. 4 and FIG. 5.

A printed wiring board 306 is arranged to face side surfaces of the unit batteries 301 from which the negative electrode terminals 302 and the positive electrode terminals 303 extend. A thermistor 307, a protection circuit 308 and a terminal 309 for conduction to an external device are mounted on the printed wiring board 306, as shown in FIG. 5. In addition, an insulating plate (not shown) is attached to a surface of the printed wiring board 306 facing the assembled battery 305, so as to avoid unnecessary connection with the wiring of the assembled battery 305.

A positive electrode side lead 310 is connected to the positive electrode terminal 303 located at the lowermost layer of the assembled battery 305, and its tip is inserted into a positive electrode side connector 311 of the printed wiring board 306, and is electrically connected thereto. A negative electrode side lead 312 is connected to the negative electrode terminal 302 located at the uppermost layer of the assembled battery 305, and its tip is inserted into a negative electrode side connector 313 of the printed wiring board 306, and is electrically connected thereto. The positive electrode side connector 311, and the negative electrode side connector 313 are connected to the protection circuit 308 through wirings 314, 315 formed in the printed wiring board 306, respectively.

The thermistor 307 is used for detecting a temperature of the unit battery 305, and though the illustration is omitted in FIG. 4, it is provided in the vicinity of the unit battery 305, and its detection signal is transmitted to the protection circuit 308. The protection circuit 308 can break a plus side wiring 316a and a minus side wiring 316 between the protection circuit 308 and the terminal 309 for conduction to an external device, under a prescribed condition. The prescribed condition is a time when a detection temperature of the thermistor 307 becomes not less than a prescribed temperature, for example. In addition, the prescribed condition is a time when over-charge, over-discharge, overcurrent or the like of the unit battery 301 is detected. Detection of this over-charge or the like is performed for each unit battery 301, or for the whole unit batteries 301. In the case of detecting each of the unit batteries 301, a battery voltage may be detected, or a positive electrode potential or a negative electrode potential may be detected. In the case of the latter, a lithium electrode which is used as a reference electrode is inserted in each of the unit batteries 301. In the case of FIG. 4 and FIG. 5, wirings 317 for voltage detection are connected to the respective unit batteries 301, and the detection signals are transmitted to the protection circuit 308 through these wirings 317.

As shown in FIG. 4, at three side surfaces of the assembled battery 305 except a side surface from which the positive electrode terminals 303 and the negative electrode terminals 302 project, protection sheets 318 composed of rubber or resin are respectively arranged.

The assembled battery 305, along with the respective protection sheets 318 and the printed wiring board 306 are housed in a housing container 319. That is, the protection sheets 318 are respectively arranged on the both inner side surfaces in the long side direction, and on an inner side surface in the short side direction, in the housing container 309, and the printed wiring board 306 is arranged on an inner side surface at the opposite side in the short side direction. The assembled battery 305 is located in a space surrounded by the protection sheets 318 and the printed wiring board 306. A lid 320 is attached on an upper surface of the housing container 319.

In addition, a heat shrinkable tape may be used, in place of the adhesive tape 304, for fixing the assembled battery 305. In this case, the protection sheets are arranged at the both side surfaces of the assembled battery, and a heat shrinkable tape is wound around them, and then the heat shrinkable tape is thermally shrunk, to bind the assembled battery.

In FIG. 4, FIG. 5, a configuration in which the unit batteries 301 are connected in series is shown, but in order to increase battery capacity, they may be connected in parallel, or the series connection and parallel connection thereof may be combined. Assembled battery packs can be further connected in series, parallel.

According to the present embodiment as described above, the battery pack is provided with the nonaqueous electrolyte batteries having an excellent charge/discharge cycle performance in the above-described second embodiment, and thereby it is possible to provide the battery pack having an excellent charge/discharge cycle performance.

In addition, an aspect of the battery pack is appropriately changed according to its usage. As a usage of the battery pack, one expressing an excellent cycle characteristic when a large current is extracted is preferable. Specifically, a usage for a power source for a digital camera, and a usage for an onboard use, such as a two-wheel to four-wheel hybrid electric car, a two-wheel to four-wheel electric car, an assist bicycle or the like, can be listed. Particularly, a battery pack using the nonaqueous electrolyte battery excellent in high temperature characteristic is suitably used for an onboard use.

Hereinafter, specific examples will be listed, and the effects thereof will be described.

### Example 1

### Manufacturing of Active Material Composite Powder in which a Main Si Source is Silicon Monoxide

Powder with an average primary particle diameter of about 150 nm obtained by performing wet pulverization of silicon monoxide powder (−325 mesh) made by Sigma-Aldrich Co. was used. This pulverized silicon monoxide powder, graphite, furfuryl alcohol were added at the mass ratio of 4:1:8, and they were mixed by a bead mill using YSZ balls (0.2 mm). The solution from which YSZ balls were separated was added with acid, and hardened, and then dried, and the obtained solidified matter was held and burned in an Ar atmosphere at 1100° C., for three hours. The material after burning was pulverized by a collision plate type jet mill, and active material composite powder of two kinds (D50=8 μm and 0.5 μm) in which a main Si source is silicon monoxide, were obtained by airflow classification.

### <Manufacturing of an Electrode>

A ratio of active material composite powder in which a main Si source is silicon monoxide, and graphite to be added as the conductive agent was changed, and a Si contained amount was changed, and thereby electrode layers with different energy densities were manufactured. A binding agent to be used, a coating thickness of each layer, a particle diameter of the active material composite powder were changed, and a first charge/discharge rate and the presence or absence of separation of the electrode material were compared. Hereinafter, specific electrode manufacturing methods will be shown.

For the first layer, active material composite powder with an average particle diameter of 0.5 μm in which a main Si source is silicon monoxide, and graphite were prepared so that a mass ratio becomes 1:3, and polyimide binder is added to them so that it becomes 19 mass % of the whole electrode materials, and they were dispersed in an N-methylpyrrolidone solvent using a mixer, to prepare a coating liquid. This coating liquid was applied on a stainless-steel foil with a thickness of 10 μm and rolled, and then they were subjected to heat treatment in Ar gas at 400° C. for two hours, and thereby a first layer was manufactured.

Next, for the second layer, active material composite powder with an average particle diameter of 8 μm in which a main Si source is silicon monoxide, and graphite were prepared so that a mass ratio becomes 3:1, and sodium polyacrylate binder was added to them so that it becomes 25 mass % of the whole electrode materials, and they were dispersed in water medium using a mixer, to prepare a coating liquid. The coating liquid was applied on the first layer and rolled, and then was cut into a prescribed size, and dried in vacuum at 100° C. for twelve hours, to prepare a test electrode.

### <Charge/Discharge Test>

A battery in which counter electrodes and a reference electrode are made of metal Li, an electrolyte solution is an EC/DEC (volume ratio EC:DEC=1:2) solution of LiPF₆ (1M) was manufactured in an argon atmosphere, and a charge/discharge test thereof was performed, with n=10. Regarding the condition of the charge/discharge test, charging was performed at a current density of 1 mA/cm² until a potential difference 0.01 V between the reference electrode and the test electrode, and further constant voltage charging was performed at 0.01 V for 24 hours, and discharging was performed at a current density of 1 mA/cm² until 1.5 V, and thereby an initial charge/discharge efficiency was obtained, and the presence or absence of separation of the electrode material was examined.

Regarding following examples and comparative examples, only portions different from the example 1 will be described, and since other composition and evaluation procedures were performed in the same manner as the example 1, the description thereof will be omitted.

### Example 2

In the same configuration as the example 1, except the point that a mass ratio of the active material composite powder and graphite in the first layer is set to 3:1, the charge/discharge test was performed.

### Comparative Example 1

In the same configuration as the example 1, except the point that a mass ratio of the active material composite powder and graphite in the first layer is set to 6:1, the charge/discharge test was performed.

### Comparative Example 2

In the same configuration as the example 1, except the point that a thickness of the first layer is set to 60 μm, the charge/discharge test was performed.

### Comparative Example 3

In the same configuration as the example 1, except the point that a particle diameter of the active material composite powder of the first layer is set to 8 μm, and a particle diameter of the active material composite powder of the second layer is set to 0.5 μm, the charge/discharge test was performed.

An electrode manufacturing condition, a first charge/discharge efficiency and the presence or absence of separation of the electrode material at that time, of the examples and the comparative examples, have been shown in Table 1.

Regarding the presence or absence of separation of the electrode, when a test was performed 10 times, and a case that separation never occurred once was written as ⊚, a case that separation occurred 1-3 times as ◯, a case that separation occurred 4-7 times as Δ, a case that separation occurred 8-10 times as X.

TABLE 1

| | electrode | | | | particle | | | |
|---|---|---|---|---|---|---|---|---|
| | composition | | | | diameter | | | |
| | (active | | | | of active | | | |
| | material | | thick- | | material | | result | |
| | powder: | | ness | | composite | | | presence |
| | graphite) | | of layer | | powder | | first | or absence |
| | first | second | (μm) | | (μm) | | effi- | of |
| | layer | layer | Y₁ | Y₂ | Z₁ | Z₂ | ciency | separation |
| example 1 | 1:3 | 3:1 | 8 | 30 | 0.5 | 8 | 62% | ⊚ |
| example 2 | 3:1 | 3:1 | 8 | 30 | 0.5 | 8 | 60% | ○ |
| com- | 6:1 | 3:1 | 8 | 30 | 0.5 | 8 | 59% | Δ |
| parative | | | | | | | | |
| example 1 | | | | | | | | |
| com- | 1:3 | 3:1 | 60 | 30 | 0.5 | 8 | 58% | ○ |
| parative | | | | | | | | |
| example 2 | | | | | | | | |
| com- | 1:3 | 3:1 | 8 | 30 | 8 | 0.5 | 62% | Δ |
| parative | | | | | | | | |
| example 3 | | | | | | | | |

In the example 2, when the energy density of the first layer was increased compared with the example 1, though the separation was easy to proceed, the effect equivalent to the example 1 was obtained.

In the comparative example 1, since the energy density of the first layer was largely increased compared with the example 1, the separation was easy to occur, and thereby the effect equivalent to the example 1 was not obtained.

In the comparative example 2, since the first layer was increased compared with the example 1, the binder used amount increased, the charge/discharge efficiency decreased, and thereby the effect equivalent to the example 1 was not obtained.

In the comparative example 3, since the particle diameter of the active material composite powder of the first layer was increased compared with the example 1, the separation was easy to occur, and thereby the effect equivalent to the example 1 was not obtained.

### Example 3

### Manufacturing of Active Material Composite Powder in which a Main Si Source is Silicon

Silicon powder with an average primary particle diameter of about 40 nm made by USRN Co., graphite, furfuryl alcohol were added at the mass ratio of 4:1:8, and they were mixed by a bead mill using YSZ balls (0.2 mm). The solution from which YSZ balls were separated was added with acid, and hardened, and then dried, and the obtained solidified matter was held and burned in an Ar atmosphere at 1100° C., for three hours. The material after burning was pulverized by a collision plate type jet mill, and active material composite powder of two kinds (D50=8 μm and 0.5 μm) in which a main Si source is silicon, were obtained by airflow classification.

### <Manufacturing of an Electrode and Charge/Discharge Test>

In the same configuration as the example 1, except the point that the active material composite powder in which a main Si source is silicon is used as the active material composite powder to be used in the first layer and the second layer, the charge/discharge test was performed.

### Example 4

In the same configuration as the example 2, except the point that the active material composite powder in which a main Si source is silicon is used as the active material composite powder to be used in the first layer and the second layer, the charge/discharge test was performed.

### Comparative Example 4

In the same configuration as the comparative example 1, except the point that the active material composite powder in which a main Si source is silicon is used as the active material composite powder to be used in the first layer and the second layer, the charge/discharge test was performed.

### Comparative Example 5

In the same configuration as the comparative example 2, except the point that the active material composite powder in which a main Si source is silicon is used as the active material composite powder to be used in the first layer and the second layer, the charge/discharge test was performed.

### Comparative Example 6

In the same configuration as the comparative example 3, except the point that the active material composite powder in which a main Si source is silicon is used as the active material composite powder to be used in the first layer and the second layer, the charge/discharge test was performed.

### Comparative Example 7

In the same configuration as the comparative example 4, except the point that the second layer is not manufactured, and only the first layer is manufactured, the charge/discharge test was performed.

### Comparative Example 8

In the same configuration as the comparative example 4, except the point that the first layer is not manufactured, and the second layer is manufactured directly on a stainless-steel foil, the charge/discharge test was performed.

An electrode manufacturing condition, a first charge/discharge efficiency and the presence or absence of separation of the electrode material at that time, of the examples and the comparative examples, have been shown in Table 2.

TABLE 2

| | electrode | | | | particle | | | |
|---|---|---|---|---|---|---|---|---|
| | composition | | | | diameter | | | |
| | (active | | | | of active | | | |
| | material | | thick- | | material | | result | |
| | powder: | | ness | | composite | | | presence |
| | graphite) | | of layer | | powder | | first | or absence |
| | first | second | (μm) | | (μm) | | effi- | of |
| | layer | layer | Y₁ | Y₂ | Z₁ | Z₂ | ciency | separation |
| example 3 | 1:3 | 3:1 | 8 | 30 | 0.5 | 8 | 80% | ○ |
| example 4 | 3:1 | 3:1 | 8 | 30 | 0.5 | 8 | 81% | ○ |
| com- | 6:1 | 3:1 | 8 | 30 | 0.5 | 8 | 76% | X |
| parative | | | | | | | | |
| example 4 | | | | | | | | |
| com- | 1:3 | 3:1 | 60 | 30 | 0.5 | 8 | 79% | X |
| parative | | | | | | | | |
| example 5 | | | | | | | | |
| com- | 1:3 | 3:1 | 8 | 30 | 8 | 0.5 | 80% | Δ |
| parative | | | | | | | | |
| example 6 | | | | | | | | |
| com- | 3:1 | None | 8 | — | 0.5 | — | 76% | ○ |
| parative | | | | | | | | |
| example 7 | | | | | | | | |
| com- | 1:3 | 3:1 | 60 | 30 | 0.5 | 8 | 79% | X |
| parative | | | | | | | | |
| example 8 | | | | | | | | |

In the examples 3, 4, even though the energy densities of the first layer, the second layer were increased compared with the example 1, the effect equivalent to the example 1 was obtained.

In the comparative example 4, since the energy density of the first layer was largely increased compared with the example 3, the separation completely occurred, and the effect equivalent to the example 3 was not obtained.

In the comparative example 5, since the first layer was increased compared with the example 3, not only the binder used amount increased, and the charge/discharge efficiency decreased, but also the separation completely occurred, and the effect equivalent to the example 3 was not obtained.

In the comparative example 6, since the particle diameter of the active material composite powder of the first layer was increased compared with the example 3, the separation was easy to occur, and the effect equivalent to the example 3 was not obtained.

In the comparative example 7, since it was affected by the polyimide binder with a larger irreversible capacity compared with the example 4, the charge/discharge efficiency was not good, and thereby the effect equivalent to the example 4 was not obtained.

In the comparative example 8, since sodium polyacrylate with a weaker binding force compared with the example 4 was used as the binder, the separation completely occurred, and thereby the effect equivalent to the example 4 was not obtained.

Hereinafter, other electrode manufacturing compositions which can obtain good effects are added as examples.

### Example 5

In the same configuration as the example 3, except the point that polyamic is used as the binder of the first layer, the charge/discharge test was performed.

### Example 6

In the same configuration as the example 3, except the point that acrylonitrile is used as the binder of the second layer, the charge/discharge test was performed.

### Example 7

In the same configuration as the example 3, except the point that the active material composite powder in which a main Si source is silicon monoxide is used as the active material composite powder to be used in the first layer, the charge/discharge test was performed. The comparison results from the example 5 to the example 7 are shown in Table 3.

TABLE 3

| | electrode | | | | particle | | | |
|---|---|---|---|---|---|---|---|---|
| | composition | | | | diameter | | | |
| | special mention | | | | of active | | | |
| | point, | | | | material | | | |
| | binder and active | | thick- | | com- | | result | |
| | material composite | | ness | | posite | | | presence |
| | powder | | of layer | | powder | | first | or absence |
| | first | second | (μm) | | (μm) | | effi- | of |
| | layer | layer | Y₁ | Y₂ | Z₁ | Z₂ | ciency | separation |
| example | polyamic | sodium | 8 | 30 | 0.5 | 8 | 78% | ⊚ |
| 5 | | poly- | | | | | | |
| | | acrylate | | | | | | |
| example | polyimide | acrylo- | 8 | 30 | 0.5 | 8 | 80% | ⊚ |
| 6 | | nitrile | | | | | | |
| example | silicon | silicon | 8 | 30 | 0.5 | 8 | 76% | ⊚ |
| 7 | mono- | | | | | | | |
| | oxide | | | | | | | |

In the example 5, though polyamic was used differently from the example 3 as the binder, the effect equivalent to the example 3 was obtained.

In the example 6, though acrylonitrile was used differently from the example 3 as the binder, the effect equivalent to the example 3 was obtained.

In the example 7, since the active material composite powder in which a main Si source is silicon monoxide in which the first efficiency is lower, but the capacity is smaller and the energy density is smaller than the active material composite powder in which a main Si source is silicon, compared with the example 3, was used, the separation could be completely prevented. The effect equivalent to the example 3 was obtained.

In all of the examples 1-7, the binders were properly used corresponding to the objects thereof, and thereby the effects in the points of maintaining the first efficiency and the presence and absence of the separation could be obtained. But, since in the two kinds of used active material composite powder with the different main Si sources, the first charge/discharge efficiencies are greatly different, regarding the first charge/discharge efficiency, the more effect could be obtained than the effect of the binder.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode for a nonaqueous electrolyte battery, comprising:
a collector;
a first mixture layer formed on the collector; and
a second mixture layer formed on a surface of the first mixture layer which is opposite to the collector;
the first mixture layer containing a first binding agent of at least one kind of polyamic acid, polyamide-imide and polyimide; and
the second mixture layer containing a second binding agent obtained by polymerizing monomers of at least one kind of acrylic acid, methacrylic acid and acrylonitrile.

2. The electrode according to claim 1, wherein:
when an energy density per volume of the first mixture layer is set to X1, and an energy density per volume of the second mixture layer is set to X2, X1≦X2.

3. The electrode according to claim 1, wherein:
when a thickness of the first mixture layer is set to Y1, and a thickness of the second mixture layer is set to Y2, Y1≦Y2.

4. The electrode according to claim 1, wherein:
an active material of at least any one mixture layer of the first mixture layer and the second mixture layer contains at least one kind of element out of Si, Sn, Al, Ge, Pb, Bi and Sb.

5. The electrode according to claim 1, wherein:
the active material is obtained by compounding the element and carbon.

6. The electrode according to claim 1, wherein:
when an average particle diameter of a first active material of the first mixture layer is set to Z1, and an average particle diameter of a second active material of the second mixture layer is set to Z2, Z1≦Z2.

7. The electrode according to claim 1, wherein:
the acrylic acid contains carboxylic acid, and not less than 50% and not more than 90% of the carboxylic acid is neutralized by ions of at least one kind of alkali metal out of lithium, sodium, and potassium.

8. A nonaqueous electrolyte battery, comprising:
a collector;
a first mixture layer formed on the collector; and
a second mixture layer formed on a surface of the first mixture layer which is opposite to the collector;
the first mixture layer containing a first binding agent of at least one kind of polyamic acid, polyamide-imide and polyimide; and
the second mixture layer containing a second binding agent obtained by polymerizing monomers of at least one kind of acrylic acid, methacrylic acid and acrylonitrile.

9. A battery pack using a nonaqueous electrolyte battery, comprising:
the nonaqueous electrolyte battery according to claim 8.

10. The battery pack according to claim 9, further comprising:
a protection circuit; and
a terminal for conduction to an external device.
